(19) United States
(12) Patent Application Publication
(10) Pub. No.: US 2021/0300762 A1
(43) Pub. Date: Sep. 30, 2021

(54) SELF-STABILIZED DISPERSED GRAPHENE NANO-MATERIAL AND PREPARATION METHOD THEREOF

(71) Applicant: HUAQIAO UNIVERSITY, Fujian (CN)

(72) Inventors: Guohua Chen, Fujian (CN); Xinbin Qiu, Fujian (CN); Feixiang Liu, Fujian (CN)

(21) Appl. No.: 17/265,634

(22) PCT Filed: Jul. 23, 2020
(86) PCT No.: PCT/CN2020/103703

§ 371 Date: Feb. 3, 2021

(30) Foreign Application Priority Data
May 27, 2019 (CN) 201910444976.0

(51) Int. Cl. C01B 32/19

(52) U.S. Cl. CPC C01B 32/19; B82Y 30/00

(57) ABSTRACT

A self-stabilized dispersed graphene nano-material and a preparation method thereof. The self-stabilized dispersed graphene nano-material is prepared by a liquid phase exfoliation with sodium p-aminobenzenesulfonate, a natural flake graphite and an alcohol-water mixed solvent, wherein sodium p-aminobenzenesulfonate is present on the surface of graphene by π-π conjugation, physical adsorption and chemical grafting. The self-stabilized dispersed graphene nano-material has good water dispersion capacity, and excellent electrical conductivity, is easy for industrial production, and has enormous potential in graphene application.

### CROSS REFERENCE TO RELATED APPLICATION

This application claims the priority of Chinese Patent Application No. 201910444976.0, entitled “Self-stabilized dispersed graphene nano-material and preparation method thereof” filed with the China National Intellectual Property Administration on May 27, 2019, which is incorporated herein by reference in its entirety.

### TECHNICAL FIELD

The present disclosure relates to the technical field of graphene materials, and in particular to a self-stabilized dispersed graphene nano-material and a preparation method thereof.

### BACKGROUND

Graphene, as a new generation of conductive material, exhibits remarkably high electron mobility. Electron mobility of graphene having a complete structure, as measured by Kirill Bolotin who comes from the Golumbia University, is 2.5×10⁵ cm²/(V·s), which is 100 times as much as that of a single crystal silicon material, and is not affected by temperature. Each carbon atom in the graphene structure provides an unbonded π electron and could move freely on the surface of graphene crystal, imparting the graphene an ultrahigh electron mobility. Thus, the graphene, as a conductive material, exhibits a broad application prospect in many fields such as stored energy, signal transmission, sensor detection and composite material.

So far, the methods for preparing graphene mainly include redox method, liquid phase exfoliation, and mechanical exfoliation. Among them, the liquid phase exfoliation is a green method that is easier to industrialize, and is realized by mainly using a mechanism existing between the surface energy (ES) difference value between graphene and organic solvent on the one hand and the interlayer force of graphene on the other hand: i.e. the lower the surface energy difference value is, the smaller the Van der Waals force between graphene layers is, and the surface energy of graphene (E_{S-G}≈70.0 mJ·m²) and the surface energy of dimethylformamide (DMF) (E_{S-DM}≈65.0 mJ·m⁻²) are relatively closed to the surface energy of N-methylpyrrolidone (NMP) (E_{s-NMP}≈68.2 mJ·m⁻²). Therefore, the liquid phase exfoliation mainly uses such solvents to perform shear exfoliation on natural graphites, to obtain a graphene conductive filler, which is used to prepare graphene. However, such method has a low preparation efficiency, and the graphene sheet layer prepared by the same has large distribution, and has different diameter for the sheets; moreover, since DMF and NMP solvents have high toxicity, they are unsuitable for commercial applications. In recent years, there are some reports on liquid phase exfoliation of graphene material with a mixed solvent, in which the mixed solvent with surface energy similar to graphene is obtained by adjusting the ratio of the green solvent ethanol to water, and is used for exfoliation to obtain the graphene. The method is relatively simple for operation and avoids using toxic and harmful solvents. Therefore, if the toxic solvents with high boiling point can be omitted, the preparation of graphene materials containing safety and environmentally friendly dispersing solvent and no surfactants, and with high stability dispersion, high conductivity, and printing flexibility has enormous application potential.

### SUMMARY

To address the drawbacks of the prior art, an objective of the present disclosure is to provide a self-stabilized dispersed graphene nano-material.

Another objective of the present disclosure is to provide a method for preparing the self-stabilized dispersed graphene nano-material as mentioned above.

The present disclosure provides the following technical solutions:

A self-stabilized dispersed graphene nano-material, which is prepared by a liquid phase exfoliation with sodium p-aminobenzenesulfonate, a natural flake graphite and an alcohol-water mixed solvent, wherein the sodium p-aminobenzenesulfonate is present on the surface of graphene by π-π conjugation, physical adsorption and chemical grafting.

In some embodiments of the present disclosure, a mass ratio of the natural flake graphite to sodium p-aminobenzenesulfonate is in a range of (1-5):(1-10).

In some embodiments, the mass ratio of the natural flake graphite to sodium p-aminobenzenesulfonate is (1-2):(1-2).

In some embodiments of the present disclosure, the alcohol-water mixed solvent consists of water and a lower alcohol in a volume ratio of 2:3.

In some embodiments, the lower alcohol is at least one selected from the group consisting of ethanol, ethylene glycol, glycerol, isopropanol and n-butanol.

In some embodiments, the lower alcohol is isopropanol.

The method for preparing the self-stabilized dispersed graphene nano-material, comprising,

(1) mixing a natural flake graphite, an alcohol-water mixed solvent and sodium p-aminobenzenesulfonate, and subjecting the resulting mixture to a ultrasonic treatment, to obtain a graphite dispersion liquid completely dissolved in sodium p-aminobenzenesulfonate;

(2) putting the graphite dispersion liquid obtained in (1) into a grinding miller for grinding, to obtain a ground slurry; and

(3) centrifugally washing the ground slurry with a washing solvent, to obtain a precipitate, i.e. the self-stabilized dispersed graphene nano-material.

In some embodiments of the present disclosure, the grinding is performed for 12-24 h.

In some embodiments of the present disclosure, a medium used in the grinding is zirconia bead with a particle size of 2-3 mm.

In some embodiments of the present disclosure, the ultrasonic treatment is performed for 4-8 min.

The present disclosure has the following beneficial effects:

1. The self-stabilized dispersed graphene nano-material according to the present disclosure could ensure its stable presence in a dispersion system.

2. The self-stabilized dispersed graphene nano-material according to the present disclosure has excellent conductivity, and complete SP² hybrid structure.

3. The preparation method according to the present disclosure enables high yield and large production.

4. The self-stabilized dispersed graphene nano-material according to the present disclosure has good aqueous dispersion capability, and excellent electrical conductivity, is easy for industrial production, and has enormous potential in graphene application.

### BRIEF DESCRIPTION OF THE DRAWINGS

FIG. 1 shows a structural schematic diagram of the self-stabilized dispersed graphene nano-material according to an embodiment of the present disclosure.

FIG. 2 shows a diagram illustrating a liquid phase exfoliation mechanism of the self-stabilized dispersed graphene nano-materials as prepared in the present disclosure.

FIG. 3 shows a diagram illustrating the dispersion state of the self-stabilized dispersed graphene nano-material according to an embodiment of the present disclosure dispersed in a dispersion liquid (20 mg/mL) consisting of isopropanol and water in a Vᵢₛₒₚᵣₒₚₐₙₒₗ/V_{water}=3/2.

FIG. 4 shows a transmission electron microscope image of the self-stabilized dispersed graphene nano-material according to an embodiment of the present disclosure,

FIG. 5 shows an atomic force microscope image of the self-stabilized dispersed graphene nano-material according to an embodiment of the present disclosure.

### DETAILED DESCRIPTION

The technical solutions of the present disclosure will be further illustrated and described below through specific embodiments in conjunction with the accompanying drawings.

### Example 1

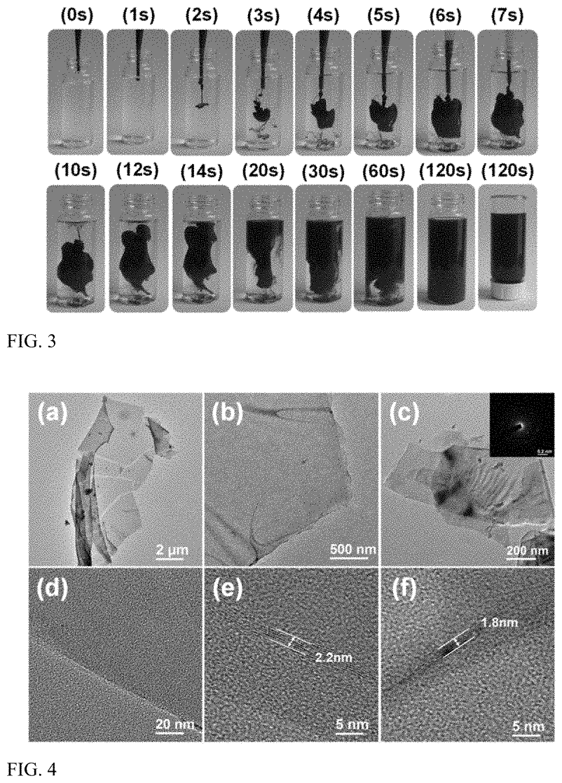

As shown in FIG. 2, according to the technical solution disclosed in the present disclosure, the following operations were performed:

(1) The following mass parts of raw materials were precisely weighed: 10 g of natural flake graphite, 10 g of sodium p-aminobenzenesulfonate, 240 mL of isopropyl alcohol, and 160 mL of distilled water. These raw materials components were mixed uniformly, and then were subjected to a high frequency ultrasonic treatment for 5 min, obtaining a graphite dispersion.

(2) The graphite dispersion in step (1) was put into a basket grinding miller with a zirconia ball with a particle diameter of 2.5 mm, and was ball milled for 24 h at a rotation speed of 2000 rpm/min, and then circularly cooled with a cooling water, obtaining a ground slurry.

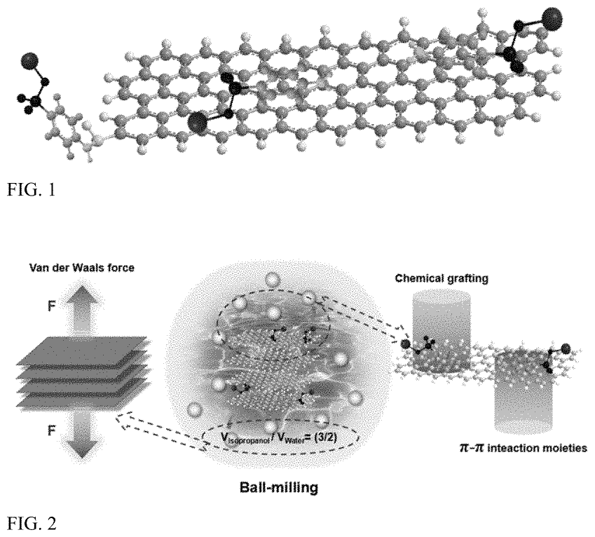

(3) The ground slurry in step (2) was centrifugally washed for 5 times with a washing solvent (consisting of isopropanol and water in a volume ratio of 3:2), obtaining a self-stabilized dispersed graphene nano-material as shown in FIG. 1. A preparation flowchart of G-SAS (i.e. self-stabilized dispersed graphene nano-material) is shown in FIG. 1.

(4) The self-stabilized dispersed graphene nano-material in step (3) was dispersed in a solvent consisting of isopropanol and water in Vᵢₛₒₚᵣₒₚₐₙₒₗ/V_{water}=3/2 (20 mg/mL), and then was tested the dispersion performance. The results were shown in FIG. 3.

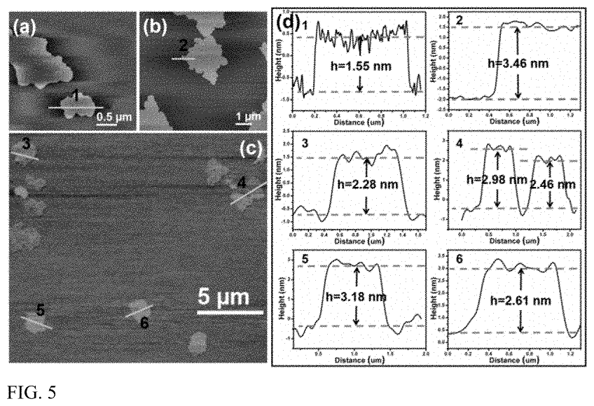

(5) The self-stabilized dispersed graphene nano-material was tested by scanning electron microscopy and atomic force microscopy, and the results were shown in FIGS. 4 and 5.

### Example 2

As shown in FIG. 2, according to the technical solution disclosed in the present disclosure, the following operations were performed:

(1) The following mass parts of raw materials were precisely weighed: 10 g of natural flake graphite, 5 g of sodium p-aminobenzenesulfonate, 240 mL of isopropyl alcohol, and 160 mL of distilled water. These raw materials components were mixed uniformly, and then were subjected to a high frequency ultrasonic treatment for 5 min, obtaining a graphite dispersion.

(2) The graphite dispersion in step (1) was put into a basket grinding miller with a zirconia ball with a particle diameter of 2.5 mm, and was ball milled for 24 h at a rotation speed of 2000 rpm/min, and then circularly cooled with a cooling water, obtaining a ground slurry.

(3) The ground slurry in step (2) was centrifugally washed for 5 times with a washing solvent (consisting of isopropanol and water in a volume ratio of 3:2), obtaining a self-stabilized dispersed graphene nano-material as shown in FIG. 1.

### Example 3

As shown in FIG. 2, according to the technical solution disclosed in the present disclosure, the following operations were performed:

(1) The following mass parts of raw materials were precisely weighed: 10 g of natural flake graphite, 2 g of sodium p-aminobenzenesulfonate, 240 mL of isopropyl alcohol, and 160 mL of distilled water. These raw materials components were mixed uniformly, and then were subjected to a high frequency ultrasonic treatment for 5 min, obtaining a graphite dispersion.

(2) The graphite dispersion in step (1) was put into a basket grinding miller with a zirconia ball with a particle diameter of 2.5 mm, and was ball milled for 24 h at a rotation speed of 2000 rpm/min, and then circularly cooled with a cooling water, obtaining a ground slurry.

(3) The ground slurry in step (2) was centrifugally washed for 5 times with a washing solvent (consisting of isopropanol and water in a volume ratio of 3:2), obtaining a self-stabilized dispersed graphene nano-material as shown in FIG. 1.

### Example 4

As shown in FIG. 2, according to the technical solution disclosed in the present disclosure, the following operations were performed:

(1) The following mass parts of raw materials were precisely weighed: 10 g of natural flake graphite, 1 g of sodium p-aminobenzenesulfonate, 240 mL of isopropyl alcohol, and 160 mL of distilled water. These raw materials components were mixed uniformly, and then were subjected to a high frequency ultrasonic treatment for 5 min, obtaining a graphite dispersion.

(2) The graphite dispersion in step (1) was put into a basket grinding miller with a zirconia ball with a particle diameter of 2.5 mm, and was ball milled for 24 h at a rotation speed of 2000 rpm/min, and then circularly cooled with a cooling water, obtaining a ground slurry.

(3) The ground slurry in step (2) was centrifugally washed for 5 times with a washing solvent (consisting of isopropanol and water in a volume ratio of 3:2), obtaining a self-stabilized dispersed graphene nano-material as shown in FIG. 1.

FIG. 1 shows a structural schematic diagram of the self-stabilized dispersed graphene nano-material according to an embodiment of the present disclosure, showing that a water-soluble SAS molecule is present on the surface of graphene by π-π conjugate and amidation reaction grafting, which improves the dispersion performance of the graphene. FIG. 2 shows a diagram illustrating a mechanism of the self-stabilized dispersed graphene nano-material as prepared in examples 1 to 4 of the present disclosure. The effect of van der Waals forces between graphene layers was reduced by liquid phase exfoliation with a solvent (consisting of isopropanol and water in Vᵢₛₒₚᵣₒₚₐₙₒₗ/V_{water}=3/2) having a surface tension matched with the surface energy of graphene. Moreover, the exfoliation efficiency was further improved by π-π conjugation between SAS exhibiting conjugated effect and the surface of graphene. In addition, the self-stabilized dispersed graphene nano-material as prepared by exfoliation of graphite under the mechanical shearing action of cyclic ball milling could ensure the dispersion stability of graphene conductive ink prepared by the same. FIG. 3 shows a diagram illustrating the effect of the prepared various graphene dispersed in a mixed solvent of isopropanol and water (in which Vᵢₛₒₚᵣₒₚₐₙₒₗ/V_{water}=3/2); as can be seen, stable dispersion could be achieved within 120 s. FIG. 4 and FIG. 5 were comprehensively analyzed, and the results show that the amount of sheet distribution of graphene is 3-8 layers.

In conclusion, the method according to the present disclosure is carried out as follows: graphene is added in a specific solvent, i.e. a mixed solvent of isopropanol and water (Vᵢₛₒₚᵣₒₚₐₙₒₗ/V_{water}=3/2), and is subjected to a liquid phase exfoliation under auxiliary effect of exfoliation agent such as sodium p-aminobenzenesulfonate, to obtain a graphene nano-flake, and the graphene nano-flake is centrifugally washed, obtaining a graphene nano-flake with an aqueous dispersion capability. The preparation method according to the present disclosure is simple and easy for operation, and graphene prepared by the same has a sheet diameter of about 2 μm, and fewer layers of graphene; thus, the graphene prepared has advantages such as good dispersion performance, excellent conductivity performance, and large production, is easy for industrial production, and has enormous potential in the application field of graphene.

The foregoing description is only a preferred embodiment of the present disclosure, and therefore the scope of the present disclosure cannot be limited thereto; that is, the equivalent changes and modifications made in accordance with the scope of the present disclosure and the contents of the specification should fall within the scope of the present disclosure.

What is claimed is:

1. A self-stabilized dispersed graphene nano-material, being prepared by a liquid phase exfoliation with sodium p-aminobenzenesulfonate, a natural flake graphite and an alcohol-water mixed solvent, wherein sodium p-aminobenzenesulfonate is present on the surface of graphene by π-π conjugation, physical adsorption and chemical grafting.

2. The self-stabilized dispersed graphene nano-material as claimed in claim 1, wherein a mass ratio of the natural flake graphite to sodium p-aminobenzenesulfonate is in a range of (1-5):(1-10).

3. The self-stabilized dispersed graphene nano-material as claimed in claim 2, wherein the mass ratio of the natural flake graphite to sodium p-aminobenzenesulfonate is in a range of (1-2):(1-2).

4. The self-stabilized dispersed graphene nano-material as claimed in claim 1, wherein the alcohol-water mixed solvent consists of water and a lower alcohol in a volume ratio of 2:3.

5. The self-stabilized dispersed graphene nano-material as claimed in claim 4, wherein the lower alcohol is at least one selected from the group consisting of ethanol, ethylene glycol, glycerol, isopropanol and n-butanol.

6. The self-stabilized dispersed graphene nano-material as claimed in claim 5, wherein the lower alcohol is isopropanol.

7. The self-stabilized dispersed graphene nano-material as claimed in claim 1, wherein the self-stabilized dispersed graphene nano-material has a sheet structure, and the amount of the sheet is in a range of 3-8.

8. A method for preparing the self-stabilized dispersed graphene nano-material as claimed in claim 1, comprising,
(1) mixing a natural flake graphite, an alcohol-water mixed solvent and sodium p-aminobenzenesulfonate, and subjecting the resulting mixture to a ultrasonic treatment, to obtain a graphite dispersion liquid completely dissolved in sodium p-aminobenzenesulfonate;
(2) putting the graphite dispersion liquid obtained in (1) into a grinding miller for grinding, to obtain a ground slurry; and
(3) centrifugally washing the ground slurry with a washing solvent, to obtain a precipitate, i.e. the self-stabilized dispersed graphene nano-material.

9. The method as claimed in claim 8, wherein the grinding is performed for 12-24 h.

10. The method of claim 8, wherein the grinding is performed with a rotation speed of 2000 rpm.

11. The method as claimed in claim 8, wherein a medium used in the grinding is zirconia bead with a particle size of 2-3 mm.

12. The method as claimed in claim 8, wherein the ultrasonic treatment is performed for 4-8 min.

13. The method as claimed in claim 8, wherein the washing solvent used in the centrifugally washing is an alcohol-water mixed solvent consisting of isopropanol and water, and a volume ratio of isopropanol to water in the alcohol-water mixed solvent is 3:2.
